(19) United States
(12) Patent Application Publication
(10) Pub. No.: US 2016/0050955 A1
(43) Pub. Date: Feb. 25, 2016

(54) METHOD AND APPARATUS FOR FORMING A HOLLOW FROZEN VESSEL

(71) Applicant: FREEDOM FINANCE AUSTRALIA, Melbourne, Victoria (AU)

(72) Inventor: Joshua Engwerda, Victoria (AU)

(21) Appl. No.: 14/779,160

(22) PCT Filed: Mar. 18, 2014
(86) PCT No.: PCT/AU2014/050004

§ 371 Date: Sep. 22, 2015

(30) Foreign Application Priority Data
Mar. 22, 2013 (AU) 2013901008
Jul. 10, 2013 (AU) 2013902546

(51) Int. Cl. A23G 9/48; F25C 1/10; C12G 3/00; A23G 9/50; A23L 2/02

(52) U.S. Cl. CPC A23G 9/485; A23G 9/506; A23L 2/02; C12G 3/00; F25C 1/10

(57) ABSTRACT

A method of forming a frozen beverage vessel, the vessel having a shell of desired thickness and transparency surrounding an interior volume, the method including: (i) providing a mould having an interior surface, the interior surface having a shape corresponding to a desired external surface shape of the shell; (ii) at least partially filling the mould with a liquid; (iii) refrigerating the at least partially filled mould; (iv) rotating the at least partially filled mould, whilst under refrigeration, about an axis of rotation such that unfrozen liquid flows over the interior surface of the mould; (v) varying the axis of rotation; and (vi) repeating steps (iv) and (v) under conditions and for a time sufficient to form the shell of desired thickness and transparency.

### TECHNICAL FIELD

The present invention relates to methods and apparatus for forming hollow frozen vessels, in some forms, the vessels are suitable for housing ingredients for a ready-to-drink cocktail.

### BACKGROUND

Those working in the bar and hospitality industry are constantly seeking novel ways to present beverages, such as cocktails, to customers. For example, cocktail waiters may serve drinks in different types of glassware, and/or garnish the drink with fruit or other decorations such as umbrellas and so on.

It would be desirable to provide an alternative means of serving beverages such as cocktails, which provides a more interactive experience for the customer, as well as being considerably faster to dispense.

### SUMMARY OF THE INVENTION

In a first aspect, the invention provides a method of forming a hollow frozen vessel, the vessel having a shell of desired thickness and transparency surrounding an interior volume, the method including:
(i) providing a mould having an interior surface, the interior surface having a shape corresponding to a desired external surface shape of the shell;
(ii) at least partially filling the mould with a liquid;
(iii) refrigerating the at least partially filled mould;
(iv) imparting rotation to the at least partially filled mould, whilst under refrigeration, about an axis of rotation such that unfrozen liquid flows over the interior surface of the mould; and
(v) perturbing the flow such that unfrozen liquid is caused to contact any portions of the internal surface not contacted during step (iv);
wherein steps (i) to (v) are carried out under conditions and for a time sufficient to form the shell of desired thickness and transparency.

In certain embodiments, the flow is perturbed by varying the axis of rotation. Advantageously, the variation in the axis of rotation of the mould assists in ensuring that unfrozen liquid contacts substantially the entire interior surface of the mould in substantially uniform fashion throughout the process, and in prevention of air bubble formation, which would otherwise lead to cloudiness of the frozen shell.

The now may be perturbed by a combination of rotating the at least partially filled mould and applying an orthogonal movement to the at least partially filled mould. The rotation and movement may be modified to optimise achievement of a relatively even shell thickness of a suitable dimension.

The variation in the axis of rotation of the mould may be achieved by changing the angle of rotation according to a logical arithmetical procedure, or by randomly (or pseudo-randomly) selecting the change in angle of rotation.

Variation in timing of rotation intervals may be achieved by changing the timing according to a logical arithmetical procedure, or by randomly (or pseudo-randomly) changing the timing of rotation intervals. The applicant has determined that tested embodiments may have uneven surfaces on either the machine or the mould, and may roll around and vary at random angles which may be very difficult or impossible to predict.

The internal space may be filled with solid, liquid or gas. Ice sculptures or small hollow ice blocks may be made with this technique.

In a second aspect, the invention provides a method of forming a hollow frozen vessel, the vessel having a shell of desired thickness and transparency surrounding an interior volume, the method including:
(i) providing a mould having an interior surface, the interior surface having a shape corresponding to a desired external surface shape of the shell;
(ii) at least partially filling the mould with a liquid;
(iii) refrigerating the at least partially filled mould;
(iv) imparting rotation to the at least partially filled mould, whilst under refrigeration, about an axis of rotation such that unfrozen liquid flows over the interior surface of the mould;
(v) varying the axis of rotation; and
repeating steps (iv) and (v) under conditions and for a time sufficient to form the shell of desired thickness and transparency.

The axis of rotation preferably passes through the mould, but need not do so.

In certain embodiments, the interior surface bounds a volume having a longest dimension defined along a longitudinal axis; wherein the axis of rotation is at a non-zero angle with respect to the longitudinal axis. It is believed that an axis of rotation which is offset from the longitudinal axis in this fashion introduces natural variation in the flow such that relatively even coverage is achieved with a single type of motion of the mould (i.e. rotation about a single, offset, axis).

Preferably, the interior surface is a surface of revolution. The surface of revolution is preferably generated from a generatrix which has a non-zero second derivative. The surface of revolution may be an ovoid, ellipsoid, prolate spheroid, oblate spheroid or lentoid, for example.

Advantageously, imparting rotation at an angle to the longest dimension of the volume bounded by the interior surface allows even coverage of the interior surface, and a substantially uniform shell thickness to be obtained, whilst only requiring a single axis of rotation in order to do so.

The method of preferred embodiments of the invention provides a means to form a novel beverage vessel of attractive appearance, in which cocktail ingredients (for example) can be included such that the vessel with contents can be served to a customer, inside a glass for example, with the contents visible through the vessel wall, and broken apart at the time of serving. The vessel fragments then remain in the glass and chill the cocktail as they melt. This enriches the experience of consuming the cocktail.

In certain embodiments, the mould has an exterior surface which is substantially spherical. The method may include providing a support surface on which the mould rolls to thereby rotate about the axis of rotation. The support surface is preferably located within a closed vessel within which the mould moves. Advantageously, this provides means for the unfrozen liquid to uniformly contact the mould interior surface without the use of additional moving parts to impart the rotation.

In alternative embodiments, the mould has a non-spherical exterior surface configured to roll along a support surface (again, preferably located within a closed vessel). The exterior surface may have a longest dimension defined along a longitudinal axis. The exterior surface may be ovoid, ellipsoid, or prolate spheroid, for example. An advantage of a non-spherical exterior surface such as an ovoid is that natural variation in the axis of rotation can occur as the mould rolls/rotates or is rotated, thus improving coverage of the mould interior surface by unfrozen liquid.

In certain embodiments, the axis of rotation is varied at certain intervals. The intervals may be irregular intervals, for example random or pseudo-random intervals. Alternatively, the intervals may be regular intervals, for example approximately 4 to 5 seconds apart.

The method preferably includes forming an aperture in the shell for introduction of ingredients into the interior volume. Thus, while at least some ingredients may be included when filling the mould prior to refrigeration, the formation of an aperture advantageously permits additional ingredients to be included post-formation. The aperture may be formed during the rotation and refrigeration process, for example by providing a block-out member which projects from the internal surface of the mould. The block-out member should, of course, project by a distance which is at least the desired shell thickness.

In certain embodiments the method may include introducing one or more additional ingredients into the at least partially filled mould. The additional ingredients may be solid ingredients and/or liquid ingredients. Liquid ingredients may be selected from the group including: alcoholic beverages, fruit juices, and carbonated and non-carbonated non-alcoholic beverages. Solid ingredients may be selected from the group including: fruits or fruit pieces, vegetables or vegetable pieces, herbs, spices and flowers.

Any solid ingredients are preferably included prior to formation of the shell, i.e. before refrigeration. However, it will be appreciated that some solid ingredients may be included post-formation, provided their dimensions are within the diameter of any aperture formed in the shell.

In certain embodiments, the flow is perturbed by the introduction of one or more solid ingredients.

In certain embodiments, the vessel may include a multi-layer shell. For example, an outer layer could be formed by effecting the above process with pure water as the freezable liquid. An aperture could be formed in the outer layer with a block-out member as described above. Alternatively, the aperture could be formed after the outer layer is formed, for example through the use of a heated pin. A second freezable liquid, for example water containing a small amount of food colouring, could be injected into the aperture, and the mould re-assembled (if necessary) and again subjected to refrigeration and rotation as described earlier. A clearly visible multi-layered shell effect could be produced by such a method.

In certain embodiments, the interior surface of the mould is spherical, cubic, ellipsoidal or cylindrical.

In a third aspect, the invention provides an apparatus for forming a frozen beverage vessel, the vessel having a shell of desired thickness and transparency surrounding an interior volume, the apparatus including:
a mould having an interior surface, the interior surface having a shape corresponding to a desired external surface shape of the shell, the mould being configured to receive a freezable liquid; and
means for repeatedly:
   rotating the mould, whilst under refrigeration, about an axis of rotation such that unfrozen liquid flows over the interior surface of the mould; and
   varying the axis of rotation,
   under conditions and for a time sufficient to form the shell of desired thickness and transparency.

In a fourth aspect, the invention provides an apparatus for forming a frozen beverage vessel, the vessel having a shell of desired thickness and transparency surrounding an interior volume, the apparatus including:
a mould having an interior surface, the interior surface having a shape corresponding to a desired external surface shape of the shell, the mould being configured to be at least partially filled with a freezable liquid; and
means for imparting rotation to the at least partially tilled mould, whilst under refrigeration, about an axis of rotation such that unfrozen liquid flows over the interior surface of the mould, under conditions and for a time sufficient to form the shell of desired thickness and transparency;
wherein the interior surface bounds a volume having a longest dimension defined along a longitudinal axis; and wherein the axis of rotation is at a non-zero angle with respect to the longitudinal axis.

Preferably, the interior surface is a surface of revolution. The surface of revolution is preferably generated from a generatrix which has a non-zero second derivative. The surface of revolution may be an ovoid, ellipsoid, prolate spheroid, oblate spheroid or lentoid, for example.

The apparatus may include a housing in which the mould is retained, the housing being pivotably mounted to a support for rotating the at least partially filled mould whilst the mould is retained. In some embodiments, the mould may move within the housing. Alternatively, the mould may itself be pivotably mounted to a support. The means for varying the axis of rotation may be a second pivot point about which the mould and/or housing is rotated.

In certain embodiments, the mould has a substantially spherical external surface. In other embodiments, the mould has a non-spherical exterior surface, which may be ovoid, ellipsoid, or prolate spheroid, for example.

The apparatus may include a channel (which may be linear or curved) along which the mould is constrained to roll. The channel may be formed by guide rails or may be a tubular guide within which the mould rolls. The channel may be located within the apparatus housing.

In certain embodiments, the mould may be frictionally engageable with a wheel or roller which rotates to thereby impart rotation to the mould about the axis of rotation. The wheel or roller may be pivotable in a plane parallel to the axis of rotation, to thereby vary the axis of rotation. The pivoting of the wheel may be actuated by a servo arm or like component. The servo arm may be coupled to a controller which is configured to pivot the wheel at certain intervals, for example at constant intervals or in accordance with a predetermined schedule. Alternatively, the controller may be configured to pivot the wheel at pseudo-random intervals (for example, through the use of a random number generator).

### BRIEF DESCRIPTION OF THE DRAWINGS

Preferred embodiments of the invention will now be described, by way of non-limiting example only, with reference to the accompanying drawings in which:

FIG. 1 is a schematic depiction of an embodiment of an apparatus for forming a frozen beverage vessel;

FIG. 2 is a schematic depiction of an alternative embodiment of an apparatus for forming a frozen beverage vessel;

FIG. 3 is a schematic depiction of a further alternative embodiment of an apparatus for forming a frozen beverage vessel;

FIG. 4 shows a schematic view of a yet further alternative embodiment of an apparatus for forming a frozen beverage vessel;

FIGS. 5 and 6 depict means for varying the axis of rotation of the apparatus of FIG. 4; and

FIGS. 7 and 8 show a variant of the apparatus of FIGS. 4 to 6.

### DETAILED DESCRIPTION

Embodiments of the invention provide a method of forming a frozen beverage vessel having a shell of desired thickness and transparency surrounding an internal volume. The shell is preferably highly transparent in order to allow ingredients in the internal volume to be easily visualised. The shell is preferably formed of ice, and can house liquid and solid ingredients, for example alcoholic and non-alcoholic beverage components of a cocktail, together with garnishes of fruit pieces, herbs etc. In embodiments, therefore, the invention provides a “ready-to-drink” cocktail in which the cocktail ingredients are housed in an ice shell. The ice shell can be placed in a glass and ruptured after being served to a customer, to release the ingredients which then mix with the ice fragments. Service of the beverage may also include additional steps, for example pouring further liquid ingredients into the glass.

Exemplary embodiments of the method include providing a mould having an exterior surface and an interior surface. The interior surface has a shape corresponding to a desired external surface shape of the shell, and is preferably spherical, but can be any one of a variety of other shapes, including ellipsoidal, cubic or cylindrical, for example. The mould is at least partially filled with a liquid (typically water) which will be frozen to form the shell. Other ingredients, for example solid ingredients, may also be added at this stage. The at least partially filled mould is then placed under refrigeration. Whilst under refrigeration, the mould is rotated about an axis of rotation such that unfrozen liquid flows over the interior surface of the mould. During the rotation, the axis of rotation is varied at regular or irregular intervals. The rotation and variation process is repeated under conditions and for a time sufficient to form a frozen shell of the desired (substantially uniform) thickness and transparency.

Perturbation of the axis of rotation assists in ensuring that unfrozen liquid contacts substantially the entire interior surface of the mould in substantially uniform fashion throughout the process, and in prevention of air bubble formation, which would otherwise lead to cloudiness of the shell.

In certain embodiments, the interior surface bounds a volume having a longest dimension defined along a longitudinal axis, the axis of rotation is at a non-zero angle with respect to the longitudinal axis. For example, the interior surface may be ovoid (egg-shaped) and the axis of rotation chosen to be at an angle of 30 degrees relative to the long axis of the ovoid. Advantageously, it has been found that shells of substantially uniform thickness can be obtained in this way, without needing to actively perturb the axis of rotation, since the offset axis itself tends to produce a perturbation in the flow of liquid over the interior surface of the mould.

The mould is preferably rotated slowly enough to avoid bruising of solid inclusions such as fruit pieces, whilst still being rotated quickly enough to ensure that there is sufficient agitation to avoid air bubble formation, to avoid solid ingredients from freezing to the interior wall of the mould, and to reduce the risk of formation of ice sheets. In this regard, it is thought that solid inclusions assist in agitation at lower speeds. In a presently preferred embodiment, the mould is rotated at between 6 rpm and 8 rpm. The axis of rotation may be perturbed approximately every 4 to 5 seconds.

A low rate of rotation may be advantageous for several additional reasons. For example, lower rotation rates will entail lower power consumption, and make it easier to provide a compact apparatus for performing the method, as faster rotation rates are mechanically more difficult to produce in small spaces.

It will be understood that the optimal range of rotation rates will, in general, depend on the temperature at which the mould is refrigerated. For example, if the temperature is too low for a given rate of rotation, the water could freeze in layers which are too thick and which contain air bubbles (therefore lacking the desired transparency) and cause solid ingredients to be frozen into the shell. The upper limit of the optimal range may be determined according to whether the rotation rate is fast enough to cause damage to solid ingredients (which may depend on the nature of the ingredients themselves; a lemon wedge, for example, being more susceptible to damage than a cinnamon stick) and/or whether the centrifugal force applied to solid ingredients would be high enough to push solid ingredients against the inner surface of the mould, thereby reducing the integrity of the ice shell.

The optimal rate of rotation may also depend on other factors such as whether the rotation is continuous.

With reference to the Figures, there will now be described a number of exemplary embodiments of apparatus for implementing the above methods.

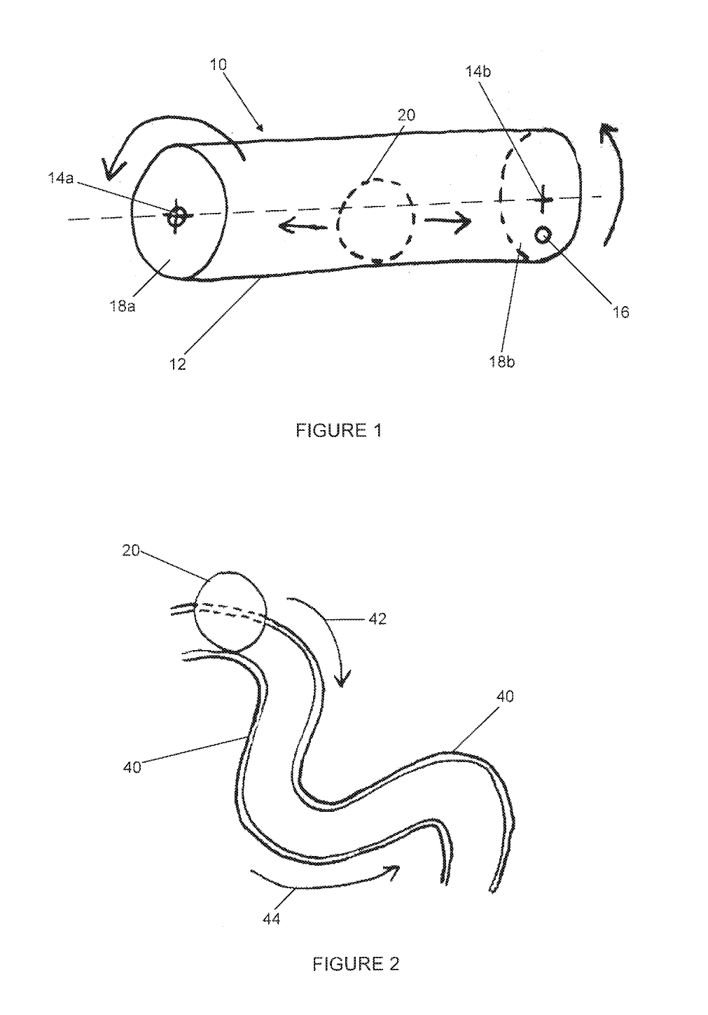

Turning to FIG. 1, there is shown an apparatus 10 having a cylindrical tube 12 for receiving a mould 20. The tube 12 has an axis of rotation passing through pivot points 14a and 16. The axis of rotation is offset from the central axis 14 of tube 12, which passes through the centres 14a, 14b of respective ends 18a, 18b of the tube 12. The pivot points 14a and 16 may be spindles which are mounted to a frame (not shown), for example. Rotation may be imparted to the tube 12 in any manner known in the art, for example by use of a belt drive (not shown).

The mould 20 has a spherical outer surface. Preferably, the inner surface of the mould 20 is also spherical, but it may have a wide variety of alternative three-dimensional shapes, such as cylindrical, cubic or ovoid/ellipsoidal, for example, or may even have an irregularly-shaped inner surface, A spherical inner surface is preferred as it allows the internal volume available for ingredients to be maximised for a given shell thickness. However, as mentioned above, a non-spherical inner surface may be advantageous in certain situations.

A spherical outer surface for mould 20 is preferred as it allows the mould to be used with much wider variety of apparatus for imparting rotation of one type or another to the mould while it is under refrigeration. However, in certain situations, it may be preferable to provide a non-spherical outer surface (such as an ovoid, ellipsoid, prolate spheroid etc.). For example, in a “tumbler”-type apparatus such as that shown in FIG. 1 and described below, it has been found that the motion of irregularly-shaped moulds such as egg-shaped moulds is favourable to production of shells of even thickness and high clarity.

The mould 20 may be a hollow sphere having a thin wall of plastics material, which may have a pre-formed aperture for insertion of liquid (to be frozen to form the ice shell) and solid ingredients. Alternatively, an incision Can be made in the mould 20 to form the aperture. Preferably, the wall of the mould 20 is resiliently deformable such that after any solid ingredients have been inserted by deforming the wall in the region of the aperture, the wall returns to its initial configuration. If the aperture is made narrow enough it may be possible to utilise the mould without applying any seal to prevent leakage of unfrozen liquid, if necessary, a liquid-tight seal of any suitable type can be applied in the region of the aperture.

Many other types of mould may be used with embodiments of the invention. For example, a two-part or multi-part mould (preferably, but not necessarily, of spherical shape) may be used. One part of such a two-part or multi-part mould can be filled or partially tilled with liquid (and any solid ingredients) and then the remaining part(s) attached to form a sealed partially tilled mould which can then be rotated under refrigeration.

Preferably, the mould includes means for blocking out part of the internal volume, such that the ice shell is formed with a through-hole, permitting additional ingredients to be added to the internal volume after the shell is formed. The block-out means could be a pin or other elongate body extending through the wall of the mould, or extending from the internal surface of the mould, and could be a separate component or could be integrally formed with the mould. It will be appreciated that the block-out means should project into the internal volume by a distance greater than the desired thickness of the ice shell.

The mould may of course have any desired volume, but is preferably dimensioned such that, when a shell of the desired thickness is formed, an internal volume of between 30 mL and 60 remains (corresponding to between one and two “shot” measures of alcohol).

The amount of liquid provided in mould 20 will of course depend on the desired thickness of the shell, which may in turn depend on desired handling and usage factors for the beverage vessel. For example, if the shell is made too thin then it may be too fragile for transport, storage, and so on. In addition, if alcohol and other ingredients are present in the shell internal volume, a shell which is too thin may mean that alcohol can more easily ‘melt’ or ‘corrode’ into the shell when it is subject to movement or an increase in temperature. This might reduce the length of time that the filled shell can sit outside of a freezer. On the other hand, if too much liquid is used and the shell is too thick, there may be unacceptable reduction in the internal volume; this may also provide a shell which is not frangible enough to be readily broken apart by a customer to release the internal ingredients for consumption. In preferred embodiments, the ice shell has a thickness in the range 5 mm to 15 mm. In more preferred embodiments, the ice shell has a thickness of approximately 10 mm.

The mould internal surface may have recessed portions, or relief structures, which define indicia to be formed in the surface of the finished product. For example, the indicia could include images and/or text such that branding can be applied to the surface of the ice shell.

Returning to FIG. 1, the operation of the apparatus 10 in formation of a beverage vessel will now be described. Mould 20 is filled with freezable liquid of volume sufficient to form a frozen shell of desired thickness, and is then placed inside tube 12. End caps (not shown) may be affixed to tube 12 to seal it. Tube 12 is then placed in a refrigerated environment (at less than the freezing temperature of the freezable liquid) and drive means for imparting rotation to the tube 12 is then actuated. Tube 12 begins at rest in the position shown in FIG. 1, with centre 14b below pivot point 16, and rotates slowly about the axis defined by pivot points 14a and 16. The offset between the centre 14b of tube end 18h and pivot point 16 allows the introduction of an incline down which the spherical mould 20 can roll in the direction from end 18b towards end 18a under gravity as the tube 12 rotates. As centre 14b moves to a position above pivot point 16, the incline faces in the opposite direction, such that the mould 20 can roll back in the direction from end 18a towards end 18b. The rotation of mould 20 in a first direction (about the axis of rotation of the tube 12), together with rotation in a second direction (by rolling along its spherical external surface within the tube 12), ensures that freezable liquid contacts the internal surface of the mould 20 in substantially uniform fashion such that microlayers of crystals form evenly on the mould internal surface.

In a preferred embodiment, the direction of rotation of the mould 20 along the tube is switched at approximately 4 to 5 second intervals. The switching rate will, in general, depend on the rotation rate imparted to the tube 12 by the drive means.

In an alternative embodiment, shown in FIG. 2, the mould 20 may be placed on a pair of guide rails 40 in a refrigerated environment. The guide rails 40 follow a sinuous path in an inclined plane, such that the mould 20 can roll slowly under gravity with its direction of travel (and thus rotation) changing at regular intervals. For example, in a first portion of the travel path, the mould 20 rolls in the direction indicated by arrow 42, whilst in a second portion it rolls in a second, different, direction 44 with a different direction of rotation. In the embodiment of FIG. 2, the guide rails 40 may be mounted on a pivotable structure such that the orientation of the inclined plane can be altered. This would then allow the mould 20 to roll back along the guide rails 40 along the new inclined plane. The orientation may be switched at regular or irregular intervals in order to change the direction of travel of the mould.

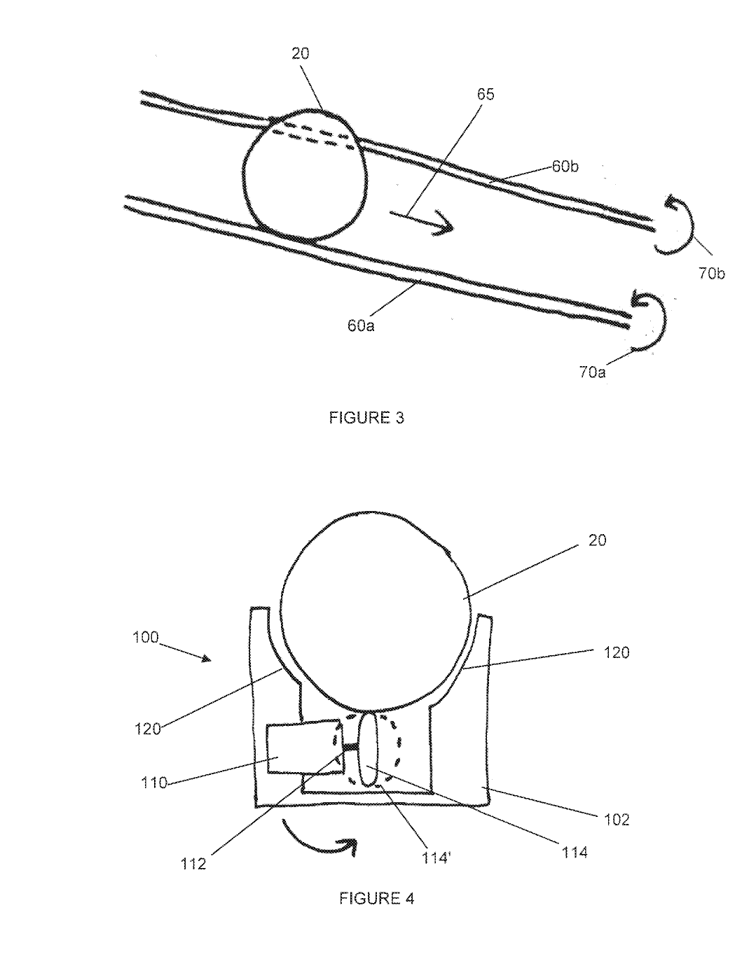

In a further alternative, shown in FIG. 3, the mould 20 rolls slowly down an incline (in the direction indicated by arrow 65) on guide rails 60a, 60b, in a refrigerated environment as for the embodiments of FIGS. 1 and 2. Guide rails 60a, 60b are rotating in the directions indicated by arrows 70a and 70b respectively, such that as the mould 20 rolls down the incline, it also rotates in the direction of arrows 70a and 70b. As for the embodiment of FIG. 2, guide rails 60a and 60b may be mounted to a pivotable structure such that the incline can be alternated, i.e. so that the mould 20 can be made to roll in a direction opposite to arrow 65 and then back in direction 65, etc.

it will be appreciated that, in each of the above embodiments, the tube 12 or guide rails 40, 60a, 60b can be dimensioned such that multiple moulds 20 can roll simultaneously down an incline. Accordingly, multiple beverage vessels can be formed in a single production run.

In each of the above-described embodiments, the process is continued for a time sufficient to freeze all of the freezable liquid in the mould 20. In alternative embodiments, the process continues until the shell is formed to the desired thickness, whether or not all of the liquid has been frozen. If any excess liquid remains then it may be removed, for example by pouring it out through the through-hole in the shell (if one is present).

In yet further embodiments, a multi-layer frozen beverage vessel could be formed. For example, an outer layer could be formed by effecting the above process with pure water as the freezable liquid, and with a through-hole formed in the outer layer with a block-out means as described above. The mould could then be removed or partially removed to expose the through-hole, and a different liquid, for example water containing a small amount of food colouring, could be injected into the through-hole, the mould re-assembled, and subjected to refrigeration and rotation as described earlier. A clearly visible multi-layered shell effect could be produced by such a method.

Referring now to FIG. 4, there is shown a schematic depiction of a yet further embodiment. The compact unit depicted in FIG. 4 may be suitable for use in a home environment, for example in a freezer of a conventional home refrigeration unit.

The unit 100 shown in FIG. 4 has a base 102 including a cavity partially defined by curved internal walls 120 which are shaped to accommodate the outer surface of the mould 20. Positioned inside the cavity is a drive component having a motor 110 to which a wheel 114 is mounted on a spindle 112. When the mould 20 rests on walls 120, it is also supported on wheel 114. Accordingly, when wheel 114 is rotated slowly about an axis along spindle 112 by motor 110, the mould 20 is caused to rotate about a substantially parallel axis of rotation (though in the opposite direction about that axis) due to frictional engagement of the wheel surface with the mould surface.

The motor 110 and wheel 114 may be rotatable relative to the base 102, for example by mounting to a rotatable support (not shown in FIG. 4), such that the axis of rotation of the wheel 114, and therefore of the mould 20, can be altered at certain intervals. The rotatable support can be moved to predetermined, fixed angular positions at certain intervals, for example by rotating the support in 90 degree increments at regular intervals, so as to pivot the axis of rotation of the wheel 114 and therefore the axis of rotation of the mould.

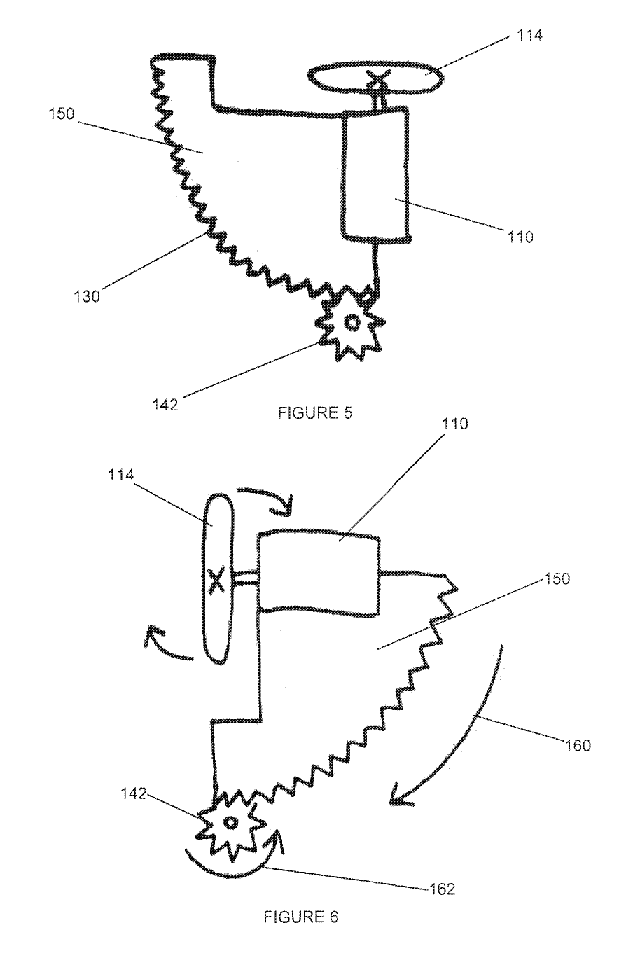

The pivoting of the wheel 114 may be achieved in various ways, including by use of a servo arm or the like. In one embodiment, as shown for illustrative purposes only in FIGS. 5 and 6, the motor 110 and wheel 114 are mounted to a rotatable base 150 with a track 130 having teeth which mesh with a gear 140 driven by a motor (not shown). As shown in FIG. 5, the wheel is initially located with its plane located at a certain orientation. In FIG. 6, as gear 142 rotates in direction 162, the rotatable base 150 rotates 90 degrees relative to the remainder of the unit 100, in direction 160, such that the plane of wheel 114 also changes its orientation, by 90 degrees relative to its initial orientation depicted in FIG. 5. Referring again to FIG. 4, the wheel 114, upon the rotation of base 150 just described, changes its orientation to the position 114 shown in phantom, such that the mould 20 changes its axis of rotation as previously described.

The servo arm or other actuation mechanism may be coupled to a controller, for example a microprocessor-based controller, which is programmed to pivot the wheel 114 at certain intervals. The intervals may be substantially constant or may be in accordance with a predetermined schedule.

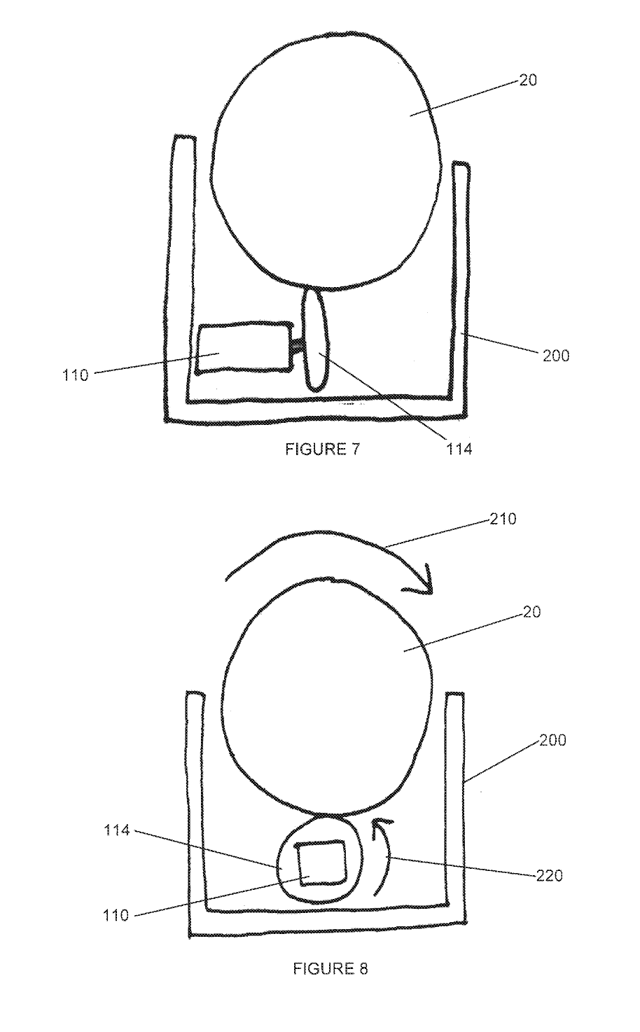

A yet further alternative is depicted in FIGS. 7 and 8. FIG. 7 shows the unit in an initial configuration in which the mould 20 rotates about an axis perpendicular to the plane of wheel 114, as in the embodiment of FIG. 4. In FIG. 8, the motor 110 and wheel 114 have been rotated through 90 degrees, for example by the mechanism described with reference to FIGS. 5 and 6, such that the axis of rotation of wheel 114 (direction of rotation depicted by arrow 210) and mould 20 (direction of rotation depicted by arrow 220) is likewise rotated through 90 degrees.

The compact unit shown in FIGS. 7 and 8 has a housing 200 which does not have a curved rest 120 to support mould 20 whilst it rotates on wheel 114. Instead, the mould 20 may be supported by alternative means, for example a retaining component (not shown) for the mould 20, such as a wire ring and/or plastic box, to ensure that the mould 20 is retained In position over the wheel 114.

As will be appreciated, once the mould 20 has been rotated under refrigeration for a sufficient time such that the final product (ice shell) is formed, the mould 20 is removed and the final product separated from the mould. At this point, in embodiments where a through-hole is formed in the shell, liquid ingredients such as alcohol, fruit juices and so on can be injected into the internal volume, for example to accompany any solid ingredients. If the shell is to be kept in refrigerated storage then it may be stored at a temperature such that any liquid ingredients which are added, including any alcoholic components, will be frozen at the intended storage temperatures. This may have benefits in terms of stability during transportation, and allowing for a greater temperature buffer for movement of shells between different freezers, for example.

An advantage of infecting alcohol into the shell interior is that it allows volatile compounds in any solid ingredients to infuse into the alcohol over time, thereby enhancing the flavour of the cocktail when consumed. If the shell is stored at a temperature less than the freezing temperature of the alcohol, then it may be moved to a higher temperature environment to allow the alcohol to return to the liquid state for infusion purposes, prior to serving.

1. A method of forming a frozen beverage vessel, the vessel having a shell of desired thickness and transparency surrounding an interior volume, the method including:
(i) providing a mould having an interior surface, the interior surface having a shape corresponding to a desired external surface shape of the shell;
(ii) at least partially filling the mould with a liquid;
(iii) refrigerating the at least partially filled mould;
(iv) rotating the at least partially filled mould, whilst under refrigeration, about an axis of rotation such that unfrozen liquid flows over the interior surface of the mould;
(v) varying the axis of rotation; and
(vi) repeating steps (iv) and (v) under conditions and for a time sufficient to form the shell of desired thickness and transparency.

2. A method of forming a frozen beverage vessel, the vessel having a shell of desired thickness and transparency surrounding an interior volume, the method including:
(i) providing a mould having an interior surface, the interior surface having a shape corresponding to a desired external surface shape of the shell;
(ii) at least partially filling the mould with a liquid;
(iii) refrigerating the at least partially filled mould;
(iv) imparting rotation to the at least partially filled mould, whilst under refrigeration, about an axis of rotation such that unfrozen liquid flows over the interior surface of the mould, under conditions and for a time sufficient to form the shell of desired thickness and transparency;
wherein the interior surface bounds a volume having a longest dimension defined along a longitudinal axis; and wherein the axis of rotation is at a non-zero angle with respect to the longitudinal axis.

3. A method according to claim 2, wherein the interior surface is a surface of revolution.

4. (canceled)

5. A method according to claim 1, wherein the mould has an exterior surface which is substantially spherical.

6. A method according to claim 1 including providing a support surface on which the mould rolls to thereby rotate about the axis of rotation.

7. A method according to claim 1, wherein the axis of rotation is varied at irregular angles, random or pseudo-random angles or regular angles.

8-10. (canceled)

11. A method according to claim 1, wherein the axis of rotation is varied at irregular intervals, random or pseudo-random intervals or regular intervals.

12-14. (canceled)

15. A method according to claim 11, wherein said regular intervals have a period of approximately 4 to 5 seconds.

16. A method according to claim 1, including introducing into the at least partially filled mould one or more additional ingredients selected from the group comprising: liquid ingredients, solid ingredients and gaseous ingredients.

17. (canceled)

18. (canceled)

19. A method according to claim 16, wherein at least one of the liquid ingredients is introduced after the shell is formed.

20. (canceled)

21. (canceled)

22. A method according to claim 16, wherein the one or more solid ingredients are introduced before refrigerating the at least partially filled mould.

23. (canceled)

24. A method according to claim 1, including forming an aperture in the shell for introduction of ingredients into the interior volume.

25. A method according to claim 1, wherein the interior surface of the mould is spherical, cubic, ellipsoidal or cylindrical.

26. An apparatus for forming a frozen beverage vessel, the vessel having a shell of desired thickness and transparency surrounding an interior volume, the apparatus including:
a mould having an interior surface, the interior surface having a shape corresponding to a desired external surface shape of the shell, the mould being configured to receive a freezable liquid; and
means for repeatedly:
rotating the mould, whilst under refrigeration, about an axis of rotation such that unfrozen liquid flows over the interior surface of the mould; and
varying the axis of rotation,
under conditions and for a time sufficient to form the shell of desired thickness and transparency.

27. (canceled)

28. Apparatus according to claim 26, including a housing in which the mould is retained, the housing being pivotably mounted to a support for rotating the at least partially filled mould whilst the mould is retained.

29-32. (canceled)

33. Apparatus according to claim 26, including a channel along which the mould is constrained to roll.

34-37. (canceled)

38. Apparatus according to claim 26, wherein the mould is frictionally engageable with a wheel or roller which rotates to thereby impart rotation to the mould about the axis of rotation.

39. Apparatus according to claim 38, wherein the wheel or roller is pivotable in a plane parallel to the axis of rotation, to thereby vary the axis of rotation.

40. Apparatus according to claim 39, including an actuator for pivoting the wheel or roller in the plane parallel to the axis of rotation.

41. Apparatus according to claim 40, wherein the actuator is coupled to a controller which is configured to pivot the wheel at constant intervals, in accordance with a predetermined schedule or at pseudo-random intervals.

42-48. (canceled)
